(19) United States
(12) Patent Application Publication
(10) Pub. No.: US 2023/0234560 A1
(43) Pub. Date: Jul. 27, 2023

(54) Method and Apparatus for Autonomous Parking Assist

(71) Applicants: Hyundai Motor Company, Seoul (KR); Kia Corporation, Seoul (KR)

(72) Inventors: Su Min Choi, Suwon-si (KR); Sun Woo Jeong, Siheung-si (KR)

(21) Appl. No.: 17/861,391

(22) Filed: Jul. 11, 2022

(30) Foreign Application Priority Data
Jan. 24, 2022 (KR) 10-2022-0010051

(51) Int. Cl. B60W 30/06; G05D 1/00; G06V 20/58

(52) U.S. Cl. CPC B60W 30/06; G05D 1/0088; G06V 20/586; G05D 2201/0213

(57) ABSTRACT

An autonomous parking assist apparatus includes a sensor unit configured to detect parking spaces and an object around a vehicle using a camera and a sensor, a video use determiner configured to determine whether a video photographed by the camera is available, a sensor fusion unit configured to receive a result of the determination of the video use determiner, using the video photographed by the camera as a basis, and substituting data in a section in which a video is unavailable with data detected using the sensor, a parking space selector configured to receive a selection of one of the parking spaces detected by the sensor unit, and a parking guide generator configured to generate parking guide information including a path along which the vehicle parks at the received one parking space, a steering angle, or a speed of the vehicle.

### CROSS-REFERENCE TO RELATED APPLICATIONS

This application claims the benefit of Korean Patent Application Number 10-2022-0010051, filed on Jan. 24, 2022, which application is hereby incorporated herein by reference.

### TECHNICAL FIELD

The present disclosure relates to an autonomous parking assist apparatus and method.

### BACKGROUND

Contents described in this section merely provide background information of the present disclosure and do not constitute a conventional technology.

As a part of the autonomous driving technology, there is autonomous parking. Autonomous parking is a technology in which a vehicle parks autonomously at a designated parking space. As a method of performing autonomous parking, there is remote smart parking assist (RSPA). The RSPA provides a driver and a passenger with convenience at the place where getting in or out of a vehicle is difficult, such as a narrow parking space, as the vehicle autonomously performs parking by using a smart key outside the vehicle. The RSPA includes a method of performing autonomous parking at a designated parking space based on an ultrasonic sensor (first RSPA) and a method of performing autonomous parking based on an SVM camera (second RSPA).

A camera may clearly identify whether an object around a vehicle is a person, a vehicle, or a thing. In contrast, ultrasonic waves may be used to detect an object around a vehicle, but are short in a detectable distance and cannot be used to accurately identify an object. The second RSPA may easily identify a parking space and an obstacle around a vehicle, compared to the first RSPA that performs autonomous parking based on ultrasonic waves, because the second RSPA performs autonomous parking based on a camera video. The second RSPA capable of easily identifying a parking space and an obstacle may perform autonomous parking more safely than the first RSPA.

In a conventional technology, a vehicle is controlled to perform autonomous parking by selectively using one of an ultrasonic sensor or a camera. The conventional technology has a problem in that a video in another direction cannot be used if only a camera in a specific direction among SVM cameras is abnormal due to the method of selectively using one of the camera or the ultrasonic sensor.

The conventional technology has a problem in that autonomous parking is performed based on an abnormal camera video because abnormality is not perfectly recognized even though the abnormality is present in some of the SVM cameras.

### SUMMARY

At least one embodiment of the present disclosure provides an autonomous parking assist apparatus comprising a sensor unit detecting a parking space and an object around a vehicle by using at least one camera and sensor included in the vehicle, a video use determination unit determining whether a video photographed by the camera is available by using a video determination algorithm, a sensor fusion unit receiving a result of the determination of the video use determination unit, using the video photographed by the camera as a basis, and substituting data in a section in which a video is unavailable with data detected using the sensor, a parking space selection unit receiving, from a driver, one of the parking spaces detected by the sensor unit, and a parking guide generation unit generating parking guide information comprising one or more of a path along which the vehicle parks at the received one parking space and a steering angle and speed of the vehicle.

Another embodiment of the present disclosure provides an autonomous parking assist method comprising a process of detecting a parking space and an object around a vehicle by using at least one camera and sensor included in the vehicle, a video use determination process of determining whether a video photographed by the camera is available by using a video determination algorithm, a process of receiving a result of the determination of the video use determination unit, using the video photographed by the camera as a basis, and substituting data in a section in which a video is unavailable with data detected using the sensor, a process of receiving one of the detected parking spaces from a driver, and a process of generating parking guide information comprising one or more of a path along which the vehicle parks at the received one parking space and a steering angle and speed of the vehicle.

### BRIEF DESCRIPTION OF THE DRAWINGS

FIG. 1 is a block diagram of an autonomous parking assist apparatus according to an embodiment of the present disclosure.

FIG. 2 is a flowchart of an autonomous parking assist method according to an embodiment of the present disclosure.

FIG. 3 is an exemplary diagram of the division of a section around a vehicle according to an embodiment of the present disclosure.

FIG. 4A to FIG. 4F are exemplary diagrams of a situation in which a video is unavailable according to an embodiment of the present disclosure.

FIG. 5A and FIG. 5B are exemplary diagrams of a method of performing autonomous parking by using camera videos in four directions according to an embodiment of the present disclosure.

FIG. 6A to FIG. 6C are exemplary diagrams of a method of performing autonomous parking in the state in which a left camera video is unavailable according to an embodiment of the present disclosure.

FIG. 7A to FIG. 7D are other exemplary diagrams of a method of performing autonomous parking in the state in which a left camera video is unavailable according to an embodiment of the present disclosure.

The following reference identifiers may be used in connection with the accompanying drawings to describe exemplary embodiments of the present disclosure.
100: Sensor unit
102: Video use determination unit
104: Sensor fusion unit
106: Parking space selection unit
108: Parking guide generation unit
110: Autonomous parking unit
112: Parking prediction unit
114: Display unit
116: Warning unit

### DETAILED DESCRIPTION OF ILLUSTRATIVE EMBODIMENTS

An autonomous parking assist apparatus according to an embodiment is based on a camera video, but may fuse data collected using an ultrasonic sensor in a section in which a camera video is unavailable and a camera video in a section in which a video is available.

An autonomous parking assist apparatus according to an embodiment may determine whether a camera video in each direction is abnormal by using a vision-fail algorithm.

Features of embodiments of the present disclosure are not limited to the aforementioned features, and the other features not described above may be evidently understood from the following description by those skilled in the art.

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

In describing the components of the embodiments, alphanumeric codes may be used such as first, second, i), ii), a), b), etc., solely for the purpose of differentiating one component from others but not to imply or suggest the substances, the order, or the sequence of the components. Throughout this specification, when parts “include” or “comprise” a component, they are meant to further include other components, not to exclude thereof unless there is a particular description contrary thereto.

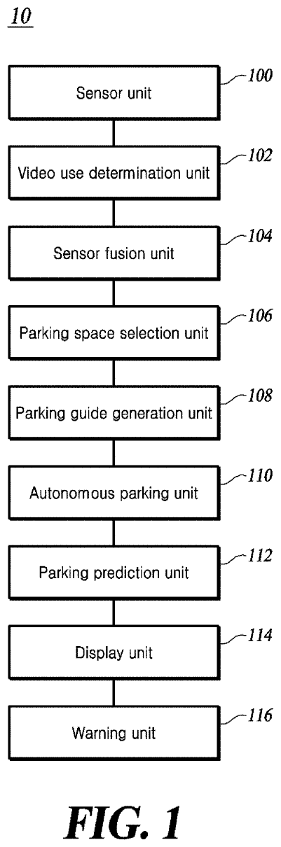

FIG. 1 is a block diagram of an autonomous parking assist apparatus according to an embodiment of the present disclosure.

Referring to FIG. 1, an autonomous parking assist apparatus 10 includes some or all of a sensor unit 100, a video use determination unit 102, a sensor fusion unit 104, a parking space selection unit 106, a parking guide generation unit 108, an autonomous parking unit 110, a parking prediction unit 112, a display unit 114, and a warning unit 116.

The sensor unit 100 detects a parking space and an object around a vehicle by using a camera and/or a sensor included in the vehicle. The sensor unit 100 may include a plurality of cameras and/or ultrasonic sensors. The sensor unit 100 divides the periphery of the vehicle into given sections, and detects a parking space and an object by using the cameras and/or the sensors for each section.

The sensor unit 100 may adjust a wide angle of the camera and/or the sensor. For example, if the video use determination unit 102 determines that a video of a left camera is unavailable, the sensor unit 100 may minimize a wide angle of the left camera and maximize a wide angle of front and back cameras. The autonomous parking assist apparatus 10 can improve the availability of the second RSPA based on a camera video because a section in which a video is unavailable can be minimized by adjusting a wide angle of a camera in each section.

The video use determination unit 102 determines whether a photographed video is available by using a video determination algorithm in order for a camera to detect a parking space for each section. The video determination algorithm representatively includes a vision-fail algorithm. The vision-fail algorithm is an algorithm for determining whether a video is available by analyzing a plurality of camera videos. For example, the vision-fail algorithm determines that a video photographed in the state in which a foreign substance is included in a camera lens cannot be used. The video determination algorithm used by the video use determination unit 102 is not limited to only the vision-fail algorithm, and may use all algorithms capable of determining a video is available.

The video use determination unit 102 determines whether a video is available even in a process of performing autonomous parking on a detected parking space. The reason for this is that a camera may be abnormal in the process of performing autonomous parking in the detected parking space even though the video is available in the process of the autonomous parking assist apparatus 10 detecting the parking space.

The sensor fusion unit 104 receives a video of a camera that detects a section in which a video is available (hereinafter a “video section”) in the corresponding section, and receives data collected by a sensor that detects a section in which a video is unavailable (hereinafter a “video-impossible section”) in the corresponding section. The sensor fusion unit 104 may fuse, into one, a video of a camera collected for each section and data collected by the sensor.

The parking space selection unit 106 receives, from a driver, one of parking spaces detected by the sensor unit 100.

The parking guide generation unit 108 receives a selected parking space from the parking space selection unit 106. The parking guide generation unit 108 generates information (hereinafter “parking guide information”) including one or more of a path along which the vehicle is parked in the selected parking space on the basis of a current location of the vehicle and a steering angle and speed of the vehicle. The parking guide information may be generated in a way that the vehicle is included in the selected parking space and does not collide against an object around the selected parking space.

The autonomous parking unit 110 controls the vehicle to autonomously perform autonomous parking in the selected parking space. A method of performing autonomous parking includes the first RSPA and the second RSPA.

The display unit 114 receives parking guide information from the parking guide generation unit 108, and generates an image or video including the received parking guide information, the vehicle, and the parking space. The display unit 114 provides the generated image or video to the driver. The display unit 114 may provide the generated image or video to the driver by using a visual output device. The visual output device includes a center infotainment display (CID), a cluster, rear seat entertainment (RSE), a head up display (HUD), etc. The CID provides vehicle driving information and entertainment by performing communication with a navigation device, a mobile device, and an audio system. The cluster provides information necessary for driving, such as a driving speed, RPM, fuel quantity, collision warning, etc. of the vehicle. The RSE is a display chiefly used for entertainment activities for a passenger at the backseat of the vehicle, and also provides a driving state of the vehicle or navigation device information. The HUD provides, as a graphic image, a current speed and remaining fuel quantity of the vehicle, and navigation device information by projecting the current speed, the remaining fuel quantity, and the navigation device information onto glass in front of the driver. However, the display is not limited thereto, and may include any device capable of providing visual information to a driver or a passenger.

The display unit 114 may generate an image or video further including the state in which the vehicle has parked at a predicted parking location by receiving a parking location predicted by the parking prediction unit 112 in real time.

The display unit 114 may generate an image or video further including words reading that a camera in a direction in which a video is unavailable is abnormal. For example, if a left camera is misted, the display unit 114 may generate words reading “please check the state in which the left camera has been misted”, and may provide the words to a driver.

If an object detected by the sensor unit 100 is at a preset distance from the vehicle, the warning unit 116 may warn a driver by using visual, auditory, and tactile outputs.

A method of the warning unit 116 using a visual output is the same as a method of the display unit 114 providing an image or video. In a method using an auditory output, an audio, an acoustic device, etc. of the vehicle may be used. A method using a tactile output is haptic. A haptic device provides information by generating a tactile output to a driver or a passenger. The haptic device includes a device mounted on a car seat, a steering wheel, etc. However, the haptic device is not limited thereto, and may include a device with which a driver comes into contact while driving the vehicle.

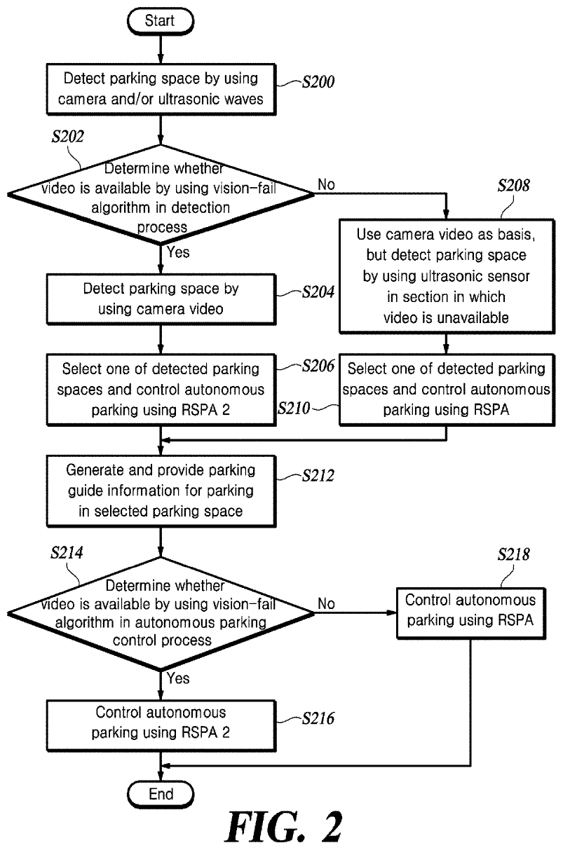

FIG. 2 is a flowchart of an autonomous parking assist method according to an embodiment of the present disclosure.

Referring to FIG. 2, the sensor unit detects a parking space and an object by using one or more cameras and/or sensors included in a vehicle (S200).

The video use determination unit receives a camera video from the sensor unit, and determines whether the received camera video is available by using the vision-fail algorithm (S202).

If the video use determination unit determines that all camera videos are available, the video use determination unit searches for a parking space by using the camera videos (S204).

The autonomous parking unit receives one of the detected parking spaces from a driver and controls the vehicle to perform autonomous parking in the selected parking space by using the second RSPA (S206).

If the video use determination unit determines that some of the camera videos are unavailable, the sensor fusion unit substitutes a video in a section in which the video is unavailable with data detected by the sensor (S208).

If one of the detected parking spaces is received from the driver and the selected parking space is a parking space in the section in which a video is available, the autonomous parking unit controls the vehicle by using the second RSPA. If the selected parking space is a parking space in the section in which a video is unavailable, the autonomous parking unit controls the vehicle by using the first RSPA (S210).

The parking guide generation unit generates information (hereinafter “parking guide information”) including one or more of a path along which the vehicle is parked in the selected parking space and a steering angle and speed of the vehicle (S212).

The video use determination unit determines whether a camera video is available in real time even in a process of performing autonomous parking (S214).

If a video in a corresponding section becomes available while performing autonomous parking using the first RSPA, the autonomous parking unit controls the first RSPA to be changed into the second RSPA and controls autonomous parking to be performed (S216).

If a video in a corresponding section becomes unavailable while performing autonomous parking using the second RSPA, the autonomous parking unit controls the second RSPA to be changed into the first RSPA and controls autonomous parking to be performed (S218).

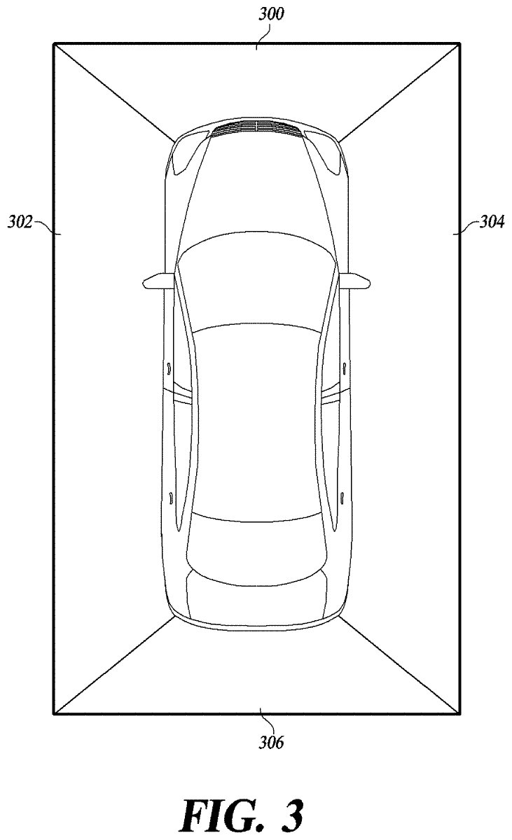

FIG. 3 is an exemplary diagram of the division of a section around a vehicle according to an embodiment of the present disclosure.

Referring to FIG. 3, the periphery of a vehicle may be divided into front (300), left (302), right (304), and back (306) sections. The periphery of the vehicle does not need to be essentially divided into the four sections. The number of sections may be different depending on the number of cameras and/or sensors included in the vehicle.

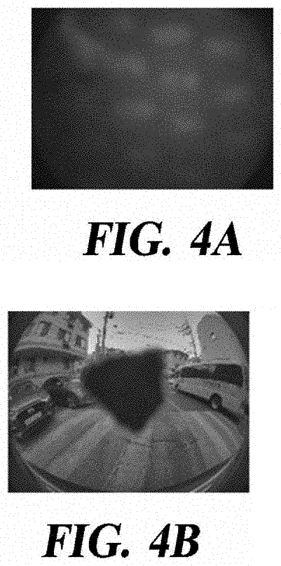

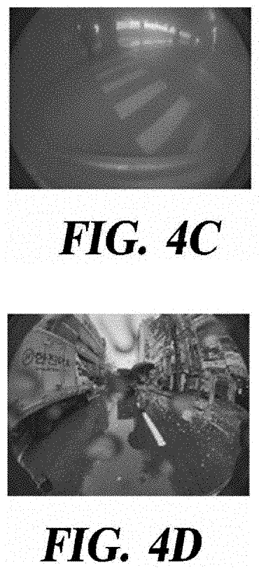

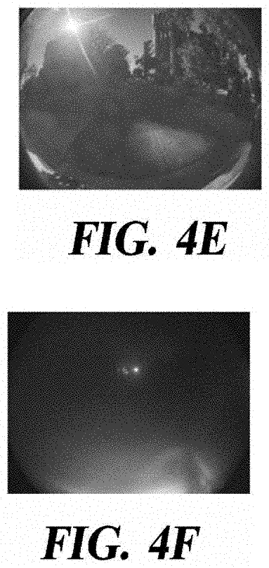

FIG. 4A to FIG. 4F are exemplary diagrams of a situation in which a video is unavailable according to an embodiment of the present disclosure.

FIG. 4A is a video photographed in the state in which a foreign substance is present on a front surface of a camera lens.

FIG. 4B is a video photographed in the state in which a foreign substance is present in a part of a camera lens.

FIG. 4C is a video photographed in the state in which the visibility of a video is low because a camera is not focused.

FIG. 4D is a video photographed in the state in which a camera lens is misted.

FIG. 4E is a video photographed in the state in which a camera does not accurately recognize the periphery of a vehicle due to backlight from the sun.

FIG. 4F is a video photographed in the state in which a camera does not accurately recognize an object due to low illuminance.

In the case of FIG. 4A to FIG. 4F, the video use determination unit determines that a corresponding video is unavailable by using the vision-fail algorithm.

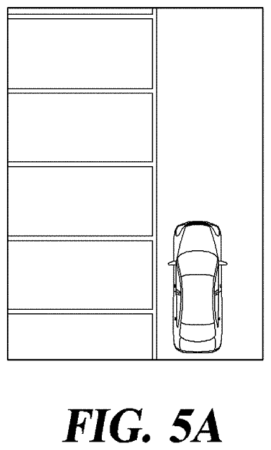

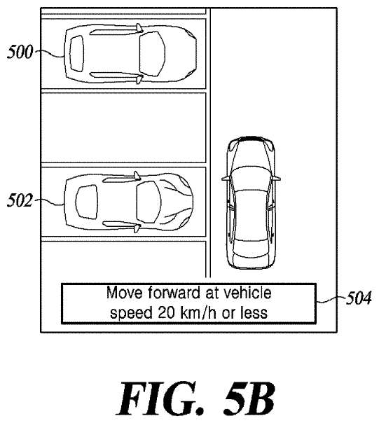

FIG. 5A and FIG. 5B are exemplary diagrams of a method of performing autonomous parking by using camera videos in four directions according to an embodiment of the present disclosure.

Referring to FIG. 5A and FIG. 5B, if all camera videos in four directions are available, the autonomous parking assist apparatus performs autonomous parking by using the second RSPA based on a camera video.

FIG. 5A illustrates videos of a vehicle photographed by using all camera videos in four directions.

Referring to FIG. 5B, the sensor unit detects a parking space based on the camera videos. The parking guide generation unit generates words 504 indicating a speed necessary for parking in the detected parking space. The parking prediction unit predicts locations 500 and 502 where the vehicle will finally park at the detected parking space based on current driving information of the vehicle. The display unit receives, from the parking guide generation unit, the words 504 indicating the speed, and receives, from the parking prediction unit, the locations 500 and 502 where the vehicle will finally park. The display unit generates an image or video including the received words 504 and the locations 500 and 502, and provides the generated image or video to a driver.

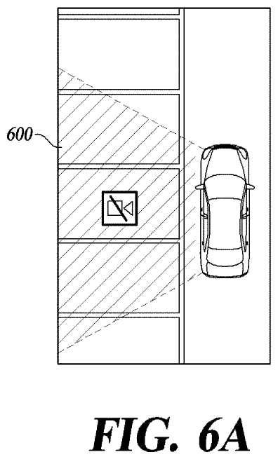

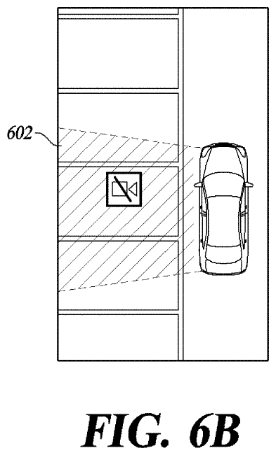

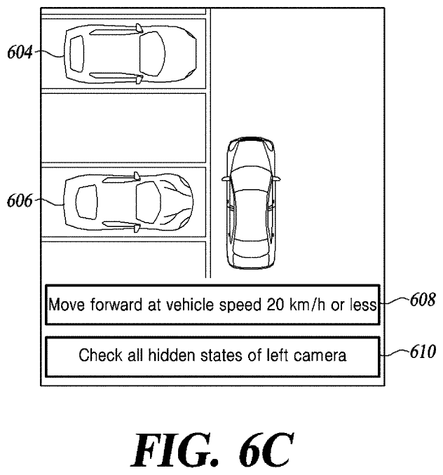

FIG. 6A to FIG. 6C are exemplary diagrams of a method of performing autonomous parking in the state in which a left camera video is unavailable according to an embodiment of the present disclosure.

FIG. 6A is a case where the video use determination unit has determined that a video captured by a camera in a left section 600 is unavailable. In this case, the sensor fusion unit is based on a camera video, but substitutes the camera video in the left section 600 with data detected by an ultrasonic sensor.

Referring to FIG. 6B, if the video use determination unit has determined that a left video is unavailable, the sensor unit may increase the availability of a camera video by minimizing a wide angle of the left camera (602) and maximizing wide angles of front and back cameras.

Referring to FIG. 6C, as in FIG. 5B, the display unit receives, from the parking guide generation unit, words 608 indicating a speed, and receives, from the parking prediction unit, locations 604 and 606 where the vehicle will finally park. The display unit generates an image or video indicating the received words 608 and the locations 604 and 606, and provides the generated image or video to a driver. The display unit may generate an image or video further including words 610 that provides notification that the left camera is abnormal, and may provide the generated image or video to the driver.

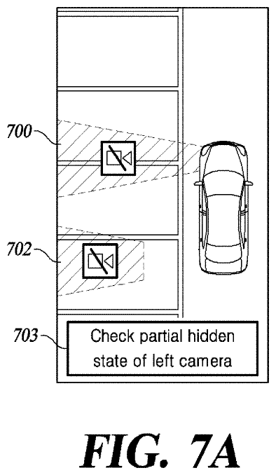

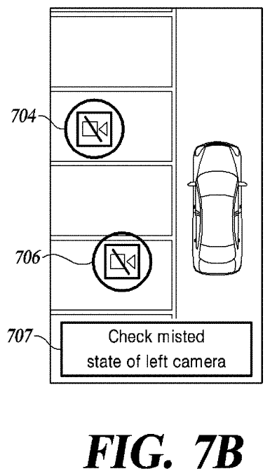

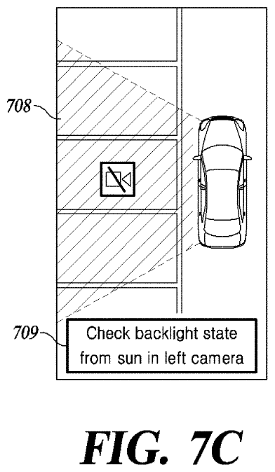

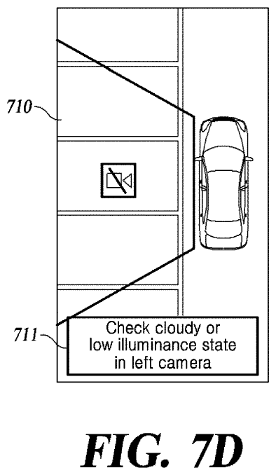

FIG. 7A to FIG. 7D are other exemplary diagrams of a method of performing autonomous parking in the state in which a left camera video is unavailable according to an embodiment of the present disclosure.

FIG. 7A is an image or video generated by the display unit based on a video photographed in the state in which a foreign substance is present in a part of a left camera lens. The sensor fusion unit substitutes parts 700 and 702 where camera videos are unavailable with data detected by an ultrasonic sensor. The display unit may provide a driver with a generated image or video by adding, to the image or video, words 703 including a reason why the camera videos are unavailable. A method of the display unit providing the driver with the image or video to which the words 703 have been added is the same as a method provided by the display unit in FIG. 7B to FIG. 7D below.

FIG. 7B is an image or video generated by the display unit based on a video photographed in the state in which a left camera lens has been misted.

FIG. 7C is an image or video generated by the display unit based on a video photographed in the state in which a camera does not accurately recognize a left section due to backlight from the sun.

FIG. 7D is an image or video generated by the display unit based on a video photographed in the state in which a camera does not accurately recognize a left section due to low illuminance.

Referring to FIG. 7A to FIG. 7D, the sensor fusion unit is based on a camera video, but substitutes a video of the section 700, 702, 704, 706, 708, or 710 in which a camera video is unavailable with data detected by the ultrasonic sensor.

In the flowchart/flow diagram of embodiments of the present disclosure, the processes have been described as being sequentially executed, but this merely illustrates the technology spirit of some embodiments of the present disclosure. In other words, a person having ordinary knowledge in the art to which some embodiments of the present disclosure pertain may variously modify and change the processes described in the flowchart/flow diagram of embodiments of the present disclosure by changing and executing the processes or executing one or more of the processes in parallel within a range that does not deviate from the intrinsic characteristic of some embodiments of the present disclosure. Accordingly, the flowchart/flow diagram of embodiments of the present disclosure is not limited to a time-series sequence.

The various implementation examples of the apparatus and method disclosed in this specification may be implemented by a programmable computer. In this case, the computer includes a programmable processor, a data storage system (including a volatile memory, a nonvolatile memory, or a different type of storage system or a combination of them), and at least one communication interface. For example, a programmable computer may be one of a server, a network device, a set-top box, an embedded device, a computer extension module, a personal computer, a laptop, a personal data assistant (PDA), a cloud computing system or a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

According to an embodiment, the autonomous parking assist apparatus can maximize the availability of the second RSPA because a camera video can be used to a maximum extent by fusing the camera video and data using ultrasonic waves.

According to an embodiment, the autonomous parking assist apparatus can use and determine a camera for each section of a camera by using the vision-fail algorithm. Accordingly, the availability of the second RSPA can be improved by minimizing a wide angle of a camera in a section in which a video is unavailable and maximizing a wide angle of a camera in a section in which a video is available.

What is claimed is:

1. An autonomous parking assist apparatus comprising:
a sensor unit configured to detect parking spaces and an object around a vehicle by using a camera and a sensor included in the vehicle;
a video use determination unit configured to determine whether a video photographed by the camera is available by using a video determination algorithm;
a sensor fusion unit configured to receive a result of the determination of the video use determination unit, using the video photographed by the camera as a basis, and substituting data in a section in which a video is unavailable with data detected using the sensor;
a parking space selection unit configured to receive a selection of one of the parking spaces detected by the sensor unit; and
a parking guide generation unit configured to generate parking guide information comprising at least one of a path along which the vehicle parks at the received one parking space, a steering angle, and a speed of the vehicle.

2. The autonomous parking assist apparatus of claim 1, wherein the video use determination unit is configured to determine whether the received one parking space is a parking space in a section in which a video is available.

3. The autonomous parking assist apparatus of claim 2, further comprising an autonomous parking unit configured to control the vehicle to perform autonomous parking by using a first remote smart parking assist (RSPA) when the received one parking space is determined to be in the section in which the video is unavailable and by using a second RSPA when the received one parking space is determined to be in the section in which the video is available.

4. The autonomous parking assist apparatus of claim 3, wherein the autonomous parking unit is configured to perform the autonomous parking by:
changing the second RSPA into the first RSPA in response to a determination of whether a video is available with respect to the video in a section comprising the received one parking space is changed from a section in which a video is available to a section in which a video is unavailable; and
changing the first RSPA into the second RSPA in response to a determination of whether the video is available with respect to the video in the section comprising the received one parking space is changed from the section in which the video is unavailable to the section in which the video is available.

5. The autonomous parking assist apparatus of claim 1, further comprising a display unit configured to generate an image or video comprising the parking guide information, the vehicle, and the parking space and to provide the generated image or video to a driver.

6. The autonomous parking assist apparatus of claim 5, wherein in response to a determination that a section in which a video is unavailable is present as a result of the determination of the video use determination unit, the display unit is configured to generate the image or video further comprising words reading that a camera in the section in which the video is unavailable is checked and to provide the generated image or video to the driver.

7. The autonomous parking assist apparatus of claim 1, further comprising a warning unit configured to warn a driver if an object detected by the sensor unit is within a preset distance from the vehicle.

8. The autonomous parking assist apparatus of claim 1, wherein in response to a section in which a video is unavailable being present as a result of the determination of the video use determination unit, the sensor unit is configured to minimize a wide angle of a camera in the section in which the video is unavailable and maximize a wide angle of a camera in a section in which a video is available.

9. An autonomous parking assist method comprising:
detecting parking space and an object around a vehicle using a camera and a sensor included in the vehicle;
determining whether a video photographed by the camera is available by using a video determination algorithm;
receiving a result of the determination using the video determination algorithm and substituting data in a section of the video photographed by the camera in which video is unavailable with data detected using the sensor;
receiving a selection of one of the detected parking spaces from a driver; and
generating parking guide information comprising at least one of a path along which the vehicle parks at the received one parking space, a steering angle, and a speed of the vehicle.

10. The autonomous parking assist method of claim 9, further comprising:
determining whether the received one parking space is a parking space in a section in which a video is available; and
controlling the vehicle to perform autonomous parking by using a first remote smart parking assist (RSPA) when the received one parking space is in the section in which the video is unavailable or by using a second RSPA when the received one parking space is in the section in which the video is available.

11. The autonomous parking assist method of claim 10, wherein:
controlling the vehicle comprises performing the autonomous parking by changing the second RSPA into the first RSPA in response to a determination of whether a video is available with respect to the video in a section comprising the received one parking space is changed from a section in which a video is available to a section in which a video is unavailable, and
controlling the vehicle comprises performing the autonomous parking by changing the first RSPA into the second RSPA in response to a determination of whether the video is available with respect to the video in the section comprising the received one parking space is changed from the section in which the video is unavailable to the section in which the video is available.

12. The autonomous parking assist method of claim 9, further comprising generating an image or video comprising the parking guide information, the vehicle, and the parking space and providing the generated image or video to the driver.

13. The autonomous parking assist method of claim 12, wherein in response to a determination that a section in which a video is unavailable is present, providing the generated image or video comprises generating an image or video further comprising words reading that a camera in the section in which the video is unavailable is checked and providing the generated image or video to the driver.

14. The autonomous parking assist method of claim 9, further comprising warning the driver if an object detected within a preset distance from the vehicle.

15. The autonomous parking assist method of claim 9, wherein in response to a section in which a video is unavailable being present, detecting the parking space and the object comprises minimizing a wide angle of a camera in the section in which the video is unavailable and maximizing a wide angle of a camera in a section in which a video is available.

16. A vehicle including an autonomous parking assist, the vehicle comprising:
a camera located in the vehicle;
a sensor located in the vehicle;
a display located in the vehicle;
a processor;
a non-transitory memory storing software that, when executed by the processor, causes the processor to:
determine whether a video photographed by the camera is available;
when the video is available, modifying the video photographed by the camera by substituting data in a section in which video is unavailable with data detected using the sensor;
selecting of a parking space detected by the camera and the sensor;
generate parking guide information that comprises at least one of a path along which the vehicle can park at the selected parking space, a steering angle, and a speed of the vehicle;
generate an image or video comprising the parking guide information, the vehicle, and the parking space;
provide the generated image or video to the display; and
providing a warning to a driver of the vehicle when an object detected by the sensor or camera is within a preset distance from the vehicle.

17. The vehicle of claim 16, wherein the software causes the processor to determine whether the selected parking space is a parking space in a section in which a video is available and to control the vehicle to perform autonomous parking by using a first remote smart parking assist (RSPA) when the selected parking space is determined to be in the section in which the video is unavailable and by using a second RSPA when the received one parking space is determined to be in the section in which the video is available.

18. The vehicle of claim 17, wherein the software causes the processor to perform the autonomous parking by:
changing the second RSPA into the first RSPA in response to a determination of whether a video is available with respect to the video in a section comprising the selected parking space is changed from a section in which a video is available to a section in which a video is unavailable; and
changing the first RSPA into the second RSPA in response to a determination of whether the video is available with respect to the video in the section comprising the selected parking space is changed from the section in which the video is unavailable to the section in which the video is available.

19. The vehicle of claim 16, wherein in response determining that a section in which a video is unavailable is present, the software causes the processor to generate the image or video including words reading that a camera in the section in which the video is unavailable is checked.

20. The vehicle of claim 16, wherein in response to determining that a video is unavailable, the software causes the processor to minimize a wide angle of the camera in the section in which the video is unavailable and maximize a wide angle of a camera in a section in which a video is available.
